(19) United States
(12) Patent Application Publication
(10) Pub. No.: US 2010/0074424 A1
(43) Pub. Date: Mar. 25, 2010

(54) COMMUNICATION APPARATUS

(75) Inventor: Koichi Ito, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA TOSHIBA, Tokyo (JP)

(21) Appl. No.: 12/509,708

(22) Filed: Jul. 27, 2009

(30) Foreign Application Priority Data
Sep. 24, 2008 (JP) 2008-244773

(51) Int. Cl. H04M 15/06

(52) U.S. Cl. 379/142.04

(57) ABSTRACT

A communication apparatus such as a cellular phone is described in which a storage device stores communication history data including outgoing call history data, incoming call history data, sent message history data, received message history data, and multi-contact data. The multi-contact data includes a part of communication history data. For example, the multi-contact data may include the most recent entry data in each of the outgoing call history data, the incoming call history data, the sent message history data, and the received message history data. The data may be displayed based the attributes of the history data or multi-contact data such as date, data type or party information.

### CROSS REFERENCE TO RELATED APPLICATIONS

This application is based upon and claims the benefit of priority from prior Japanese Patent Application No. 2008 244773, filed Sep. 24, 2008, the entire contents of which are incorporated herein by reference.

### BACKGROUND OF THE INVENTION

1. Field of the Invention

Exemplary embodiments of the present invention relate to a communication apparatus which has a plurality of communication methods and readily selects one of a plurality of communication methods to be used by using a communication history.

2. Description of the Related Art

Generally, a communication apparatus such as a cellular phone stores called and calling telephone numbers as call history information, and the communication apparatus can make an outgoing call based on a telephone number in the call history information. This is called history dialing function. In the history dialing function, a user readily makes an outgoing call by selecting a telephone number from displayed call history information since the call history information includes recently or frequently called and received telephone numbers.

Also, regarding the stored call history information, international publication WO99/22505 shows that the user may set a prohibition flag for any telephone number so as to be displayed in the call history information even if the user makes outgoing calls and receives incoming calls many times. Therefore, frequently called and received telephone numbers can remain in the dial memory, and consequently the user can use the frequently called and received telephone numbers any time.

When the user wishes to dial a telephone number which the user has dialed before, first, keys are manipulated on the communication apparatus so as to display the call history information on a display, and the keys are further manipulated to select one telephone number that the user wants to dial. On the other hand, mail history information in which addresses contained in sent and received messages is also stored in the communication apparatus. Therefore, the user can selectively use both the call history information and the mail history information.

However, the user has to switch between the call history information and the mail history information since the call history information and the mail history information are managed independently in the communication apparatus. Therefore, it is sometimes difficult to use the dial history information and mail history information if the user is not accustomed to using the communication apparatus.

### SUMMARY OF THE INVENTION

A communication apparatus includes: a storage device configured to store communication history data including a plurality of entries, contact data which includes a part of the entries in the communication history data, and phonebook data composed of at least one entry including an identification data identifying the entry, a telephone number, a mail address, and party name; a communication information extraction unit configured to extract one of a telephone number and a mail address from one of the communication history data and the contact data; a communication unit configured to make an outgoing call and send a message based on the telephone number and the mail address extracted by the communication information extraction unit; and a data management unit configured to update the communication history data and the contact data after the communication unit makes the outgoing call or sends the message.

### BRIEF DESCRIPTION OF THE DRAWINGS

The accompanying drawings, which are incorporated in and constitute a part of the specification, illustrate exemplary embodiments of the invention, and together with the general description given above and the detailed description of the exemplary embodiments given below, serve to explain the principles of the invention.

FIG. 1 shows an exemplary appearance of a cellular phone;

FIG. 2 is a block diagram of the cellular phone;

FIG. 3A shows a data structure of outgoing call history data;

FIG. 3B shows a data structure of incoming call history data;

FIG. 4A shows a data structure of sent message history data;

FIG. 4B shows a data structure of received message history data;

FIG. 5 shows a data structure of multi-contact data;

FIG. 6 is a flowchart explaining a procedure of managing history data;

FIG. 7A shows a screen image when displaying entry data in the multi-contact data;

FIG. 7B shows a screen image when displaying entry data in the outgoing call history data;

FIG. 7C shows a screen image when displaying entry data in the sent message history data;

FIG. 8 shows a data structure of the multi-contact data after the multi-contact data is updated;

FIG. 9 shows a data structure of the outgoing call history data after the outgoing call history data is updated;

FIGS. 10A-10C show a screen transition when selecting one data entry from the multi-contact data;

FIG. 11A shows a screen image when displaying internet access history data;

FIG. 11B shows a screen image when displaying entry data in the internet access history data together with the entry data in the multi-contact data; and

FIG. 11C shows a screen image when displaying specific entry data in the multi-contact data.

### DETAILED DESCRIPTION OF THE PREFERRED EMBODIMENTS

Exemplary embodiments of the present invention will be described hereinafter with reference to the accompanying drawings.

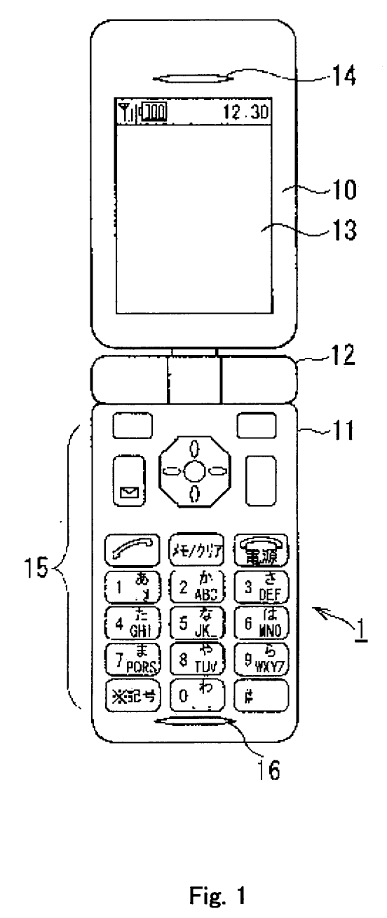

As an example of a communication apparatus, a cellular phone 1 is described in this embodiment. FIG. 1 shows an exemplary arrangement of the cellular phone 1, which provides communication information so that a user readily makes a communication with a little key operation.

As shown in FIG. 1, the cellular phone 1 is composed of a first housing 10 and a second housing 11 similar to the first housing in size, and both housings are rotatably connected via a hinge unit 12.

A front surface of the first housing 10, which faces a front surface of the second housing 11 when the cellular phone 1 is in a closed state, is equipped with a display unit 13 for displaying letters and pictures and so on. Also, the first housing 10 is equipped with a speaker 14 for outputting sound which is arranged to be covered by the second housing 11 when the cellular phone 1 is in the closed state.

On the other hand, the front surface of the second hosing 11, for example, is equipped with a key pad 15 which may include a power key for turning on and off the cellular phone 1, a call key for making an outgoing call, a numeric keypad for inputting numbers and characters, and short-cut keys for activating a mail function and web browsing function. This listing of keys is exemplary, and those skilled in the art understand that additional keys may be present. Also, a microphone 16 that captures voice is located inside of the second housing 11. The key pad 15 and the microphone 16 are covered by the first housing 10 when the cellular phone 1 is in the closed state.

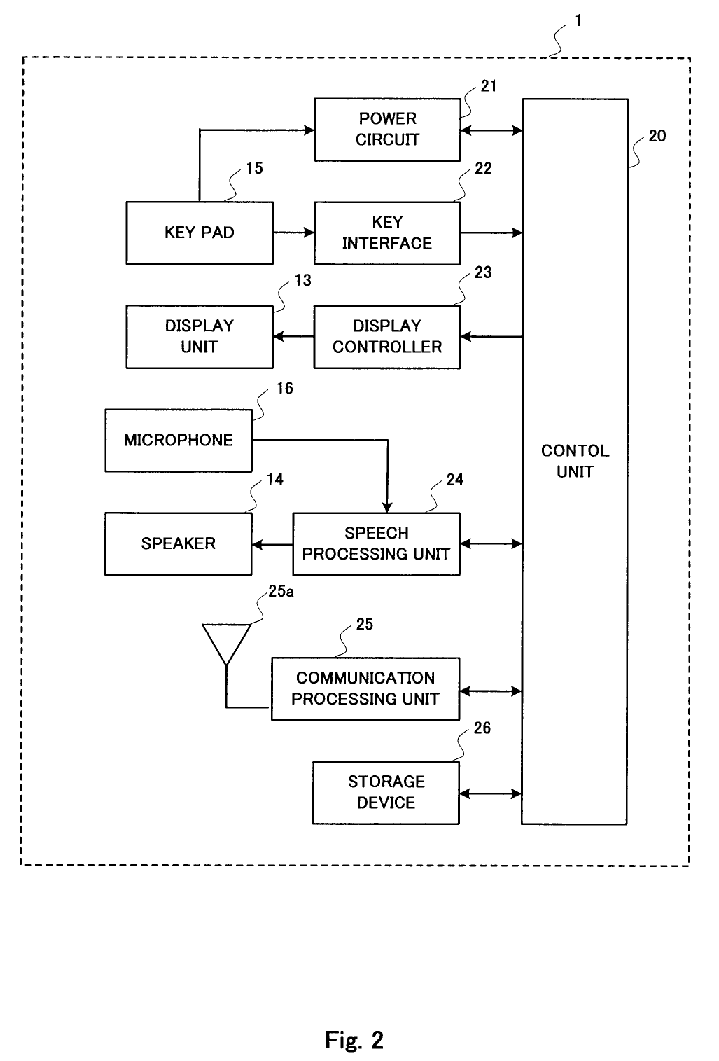

Next, function of each part of the cellular phone 1 will be described with reference to FIG. 2. As shown in FIG. 2, the cellular phone 1 may be composed of a control unit 20, a power circuit 21, a key interface 22, a display controller 23, a speech processing unit 24, a communication processing unit 25, and storage device 26. Components 20 through 26 are connected with a bus (not shown) and may communicate each other via the bus.

The control unit 20 may be a CPU (Central Processing Unit) and entirely controls the cellular phone 1. Also, the communication history is managed by control unit 20 as described in detail below.

The power circuit 21 controls a power supply from a rechargeable battery to each part of the cellular phone 1. For example, the power circuit 21 switches between a turn-on state and a turn-off state in response to a control signal outputted from the control unit 20. The control signal is outputted when the control unit 20 detects a depression of the power key.

The key interface 22 detects depression of any key of the key pad 15 and outputs a key input signal corresponding to a depressed key of the key pad 15 to the control unit 20.

The display control unit 23 interfaces with the display unit 13 and, under the control of the control unit 20, controls the display unit 13 so that text data and picture data are displayed on the display unit 13.

The speech processing unit 24 converts a user's voice captured by the microphone 16 into analog speech signals, and further converts the analog speech signals into the digital speech signals. Also, the speech processing unit 24 converts the digital speech signals received from the control unit 20 into analog speech signals to be outputted via the speaker 14.

The communication processing unit 25 de-spreads reception signals which are received from a base station via an antenna 25a and obtains a plurality of packet data. Each packet data contains one of digital speech signals, digital video signals, message signals, and control signals. If the packet data contains digital speech signals, digital speech signals are outputted from the speaker 14 via the speech processing unit 24. If the packet data contains digital video data, audio signals extracted from the video signals are outputted from the speaker 14 via the speech processing unit 24 and picture signals extracted from the video signals are displayed on the display unit 13 via the control unit 20 and the display control unit 23. On the other hand, the communication control unit 25 spreads the packet data which contains digital speech signals from the speech processing unit 24, message signals inputted by the key pad 15 or read out from the storage device 26, or video signals from the control unit 20, and generates transmission signals. The transmission signals are transmitted to the base station via the antenna 25a.

The storage device 26 may be a ROM (Read Only Memory), a HDD (Hard Disc Drive), a nonvolatile memory, or a RAM (Random Access Memory). For example, the ROM stores data application programs and data to be executed by the control unit 20, and the RAM temporarily stores data in process by the control unit 20. Also, the storage device 26 stores phonebook data including ID information, at least one entry which may be composed of a name, a picture, at least one telephone number, and at least one e-mail address, and stores outgoing call history data 30, incoming call history data 31, sent message history data 32, received message history data 33, and multi-contact data 34.

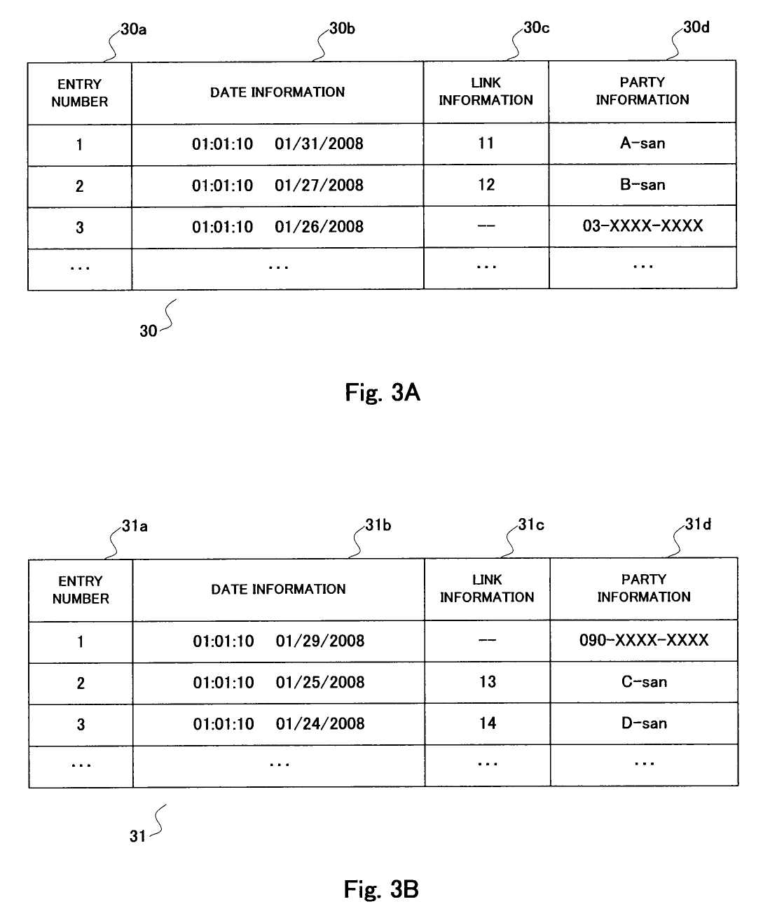

As shown in FIG. 3A, the outgoing call history data 30 includes at least one entry which may be composed of an entry number 30a, time and date information 30b identifying date and time an outgoing call is made, link information 30c identifying the ID information included in the phonebook data, and party information 30d identifying a name or a telephone number of the person called. The entries are arranged in order according to the date information 30b. The entry number 1 is assigned to the newest entry.

For example, an entry identified by the entry number 1 includes “01:01:10 01/31/2008” as the time and date information 30b, “11” as the link information 30c, and “A-san” as the party information 30d. Likewise, an entry identified by the entry number 2 includes “01:01:10 01/27/2008” as the time and date information 30b, “12” as the link information 30c, and “B-san” as the party information 30d.

As shown in FIG. 3B, the incoming call history data 31 includes at least one entry which may be composed of an entry number 31a, time and date information 31b identifying date and time an incoming call is received, link information 31c identifying the ID information included in the phonebook data, and party information 31d identifying a name or a telephone number of a caller. The entries are arranged in order according to the date information 31b. The entry number 1 is assigned to the newest entry.

For example, an entry identified by the entry number 1 includes “01:01:10 01/29/2008” as the time and date information 31b, “--” as the link information 31c, and “090-XXXX-XXXX” as the party information 31d. Likewise, an entry identified by the entry number 2 includes “01:01:10 01/25/2008” as the time and date information 31b, “13” as the link information 31c, and “C-san” as the party information 31d. The hyphen represents that no same information in the entry number is registered in the phonebook data.

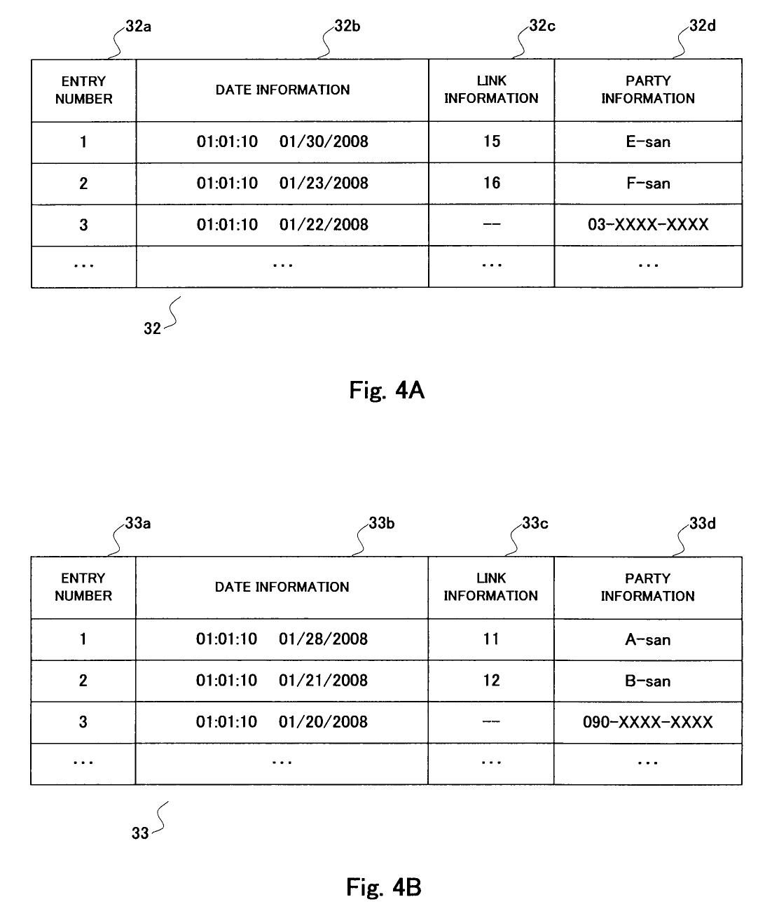

On the other hand, as shown in FIG. 4A, the sent message history data 32 includes at least one entry which may be composed of an entry number 32a, time and date information 32b identifying date and time a message, such as an e-mail and a short message, is sent, link information 32c identifying the ID information included in the phonebook data, and party information 32d identifying a name or a mail address of an addressee. The entries are arranged in order according to the date information 32b. The entry number 1 is assigned to the newest entry.

For example, an entry identified by the entry number 1 includes “01:01:10 01/30/2008” as the time and date information 32b, “15” as the link information 32c, and “E-san” as the party information 32d. Likewise, an entry identified by the entry number 2 includes “01:01:10 01/23/2008” as the time and date information 32b, “16” as the link information 32c, and “F-san” as the party information 32d. Also, an entry identified by the entry number 3 includes “01:01:10 01/22/2008” as the time and date information 32b, “--” as the link information 32c, and “xxxx@xxxx.co.jp” as the party information 32d. In this example, in the entry number 3, no same mail address is registered in the phonebook data, so the mail address is registered in place of the party information.

If the user sent an e-mail including a group address or plurality of mail addresses, the group address or the plurality of mail addresses may be stored in accordance with the sent email as the party information 32d in FIG. 4A.

As shown in FIG. 4B, the received message history data 33 includes at least one entry which may be composed of an entry number 33a, time and date information 33b identifying date and time a message, such as an e-mail and a short message, is received, link information 33c identifying the party information included in the phonebook data, and party information 33d identifying a name or a mail address of a person who sent the message. The entries are arranged in order according to the date information 33b. The entry number 1 is assigned to the newest entry.

For example, an entry identified by the entry number 1 includes “01:01:10 01/28/2008” as the time and date information 33b, “11” as the link information 33c, and “A-san” as the party information 33d. Likewise, an entry identified by the entry number 2 includes “01:01:10 01/21/2008” as the time and date information 33b, “12” as the link information 33c, and “B-san” as the party information 33d. Also, an entry identified by the entry number 3 includes “01:01:10 01/20/2008” as the time and date information 33b, “--” as the link information 33c, and “xxxx@xxxx.com” as the party information 33d. In this example, in the entry number 3, no same telephone number or mail address is registered in the phonebook data, so the mail address is registered in place of the party information.

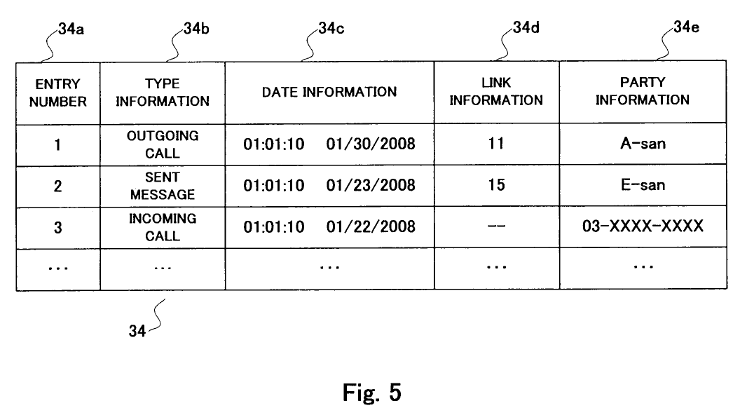

Finally, as shown in FIG. 5, the multi-contact data 34 is provided. The multi-contact data 34 may store a plurality of entries copied from specific entries in the outgoing call history data 30, the incoming call history data 31, the sent message history data 32, and the received message history data 33. As shown in FIG. 5, each entry in the multi-contact data 34 is composed of an entry number 34a, type information 34b identifying one of the incoming call, the outgoing call, message transmission, and message reception, time and date information 34c identifying the time and date when one of the incoming call, the outgoing call, sending the message, and receiving the message occurred, link information 34d identifying the ID information included in the phonebook data, and party information 34e identifying one of the name, telephone number of the person called or the caller, and the mail address of the person who sent the message or the addressee.

For example, as shown in FIG. 5, an entry identified by the entry number 1 includes “outgoing call” as the type information 34b, “01:01:10 01/31/2008” as the time and date information 34c, “11” as the link information 34d, and “A-san” as the party information 34d. Also, an entry identified by the entry number 2 includes “sent message” as the type information 34b, “01:01:10 01/30/2008” as the time and date information 34c, “15” as the link information 34d, and “E-san” as the party information 34e.

In this embodiment, the multi-contact data 34 stores the most recent entry in each of the outgoing call history data 30, the incoming call history data 31, the sent message history data 32, the received message history data 33. Therefore, when making a communication, a user of the cellular phone 1 readily selects the telephone number or the mail address, from the multi-contact data 34, which are recently used for communication, without a complicated manipulation.

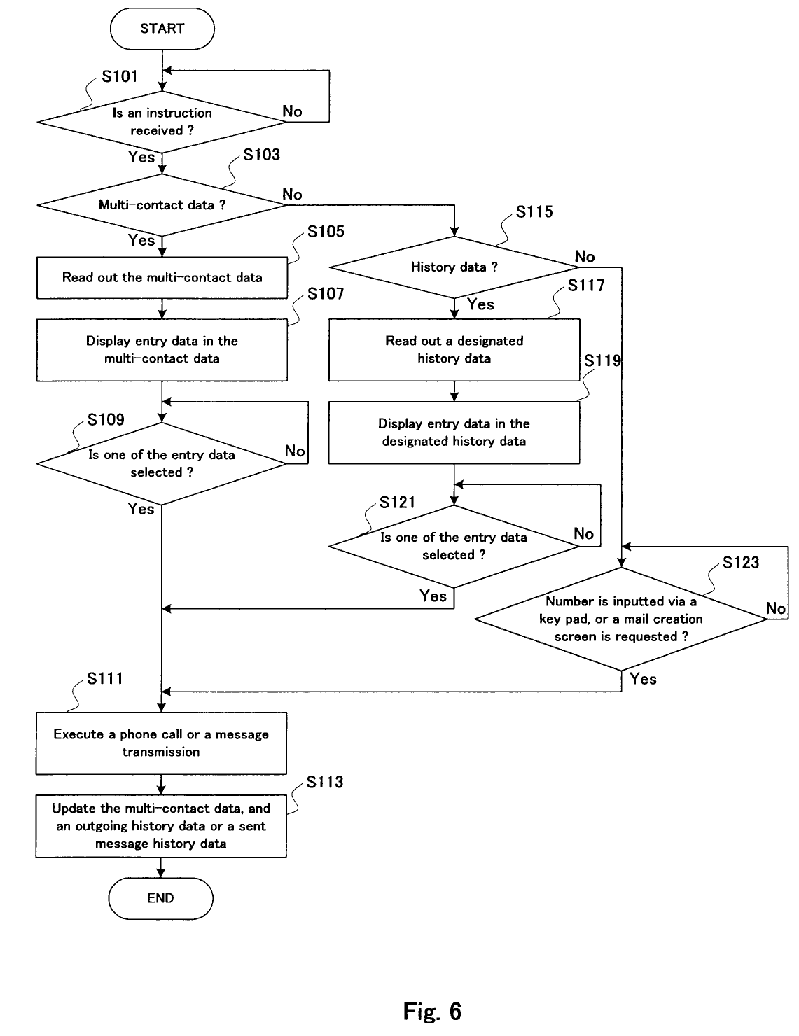

Hereinafter, procedures with respect to how to communicate by using the history data 30 through 33, and the multi-contact data 34 will be described with reference to FIG. 6.

Generally, when making a phone call or sending a message, the user may use the telephone number or the mail address in the history data 30 through 33, the multi-contact data 34, and the phonebook data selectively.

The control unit 20 of the cellular phone 1 checks whether an instruction is received via the key pad 15 (Step S101). If no instruction is received, the control unit 20 continues to check a reception of the instruction.

If the instruction, which instructs to display entry data contained in one entry, is received (Yes at Step S101), the control unit 20 checks whether an instruction to display the entry data in the multi-contact data 34 (Step S103) is received. For example, the user selects one of the history data 30 through 33, the multi-contact data 34, and the phonebook data from a menu screen displayed on the display unit 13 by manipulating the key pad 15.

If the multi-contact data is instructed to be displayed (Yes at Step S103), the control unit 20 reads out the multi-contact data 34 from the storage device 26 (Step S105). Thereafter, the control unit 20 displays each entry data in the multi-contact data 34 on the display unit 13 (Step S107).

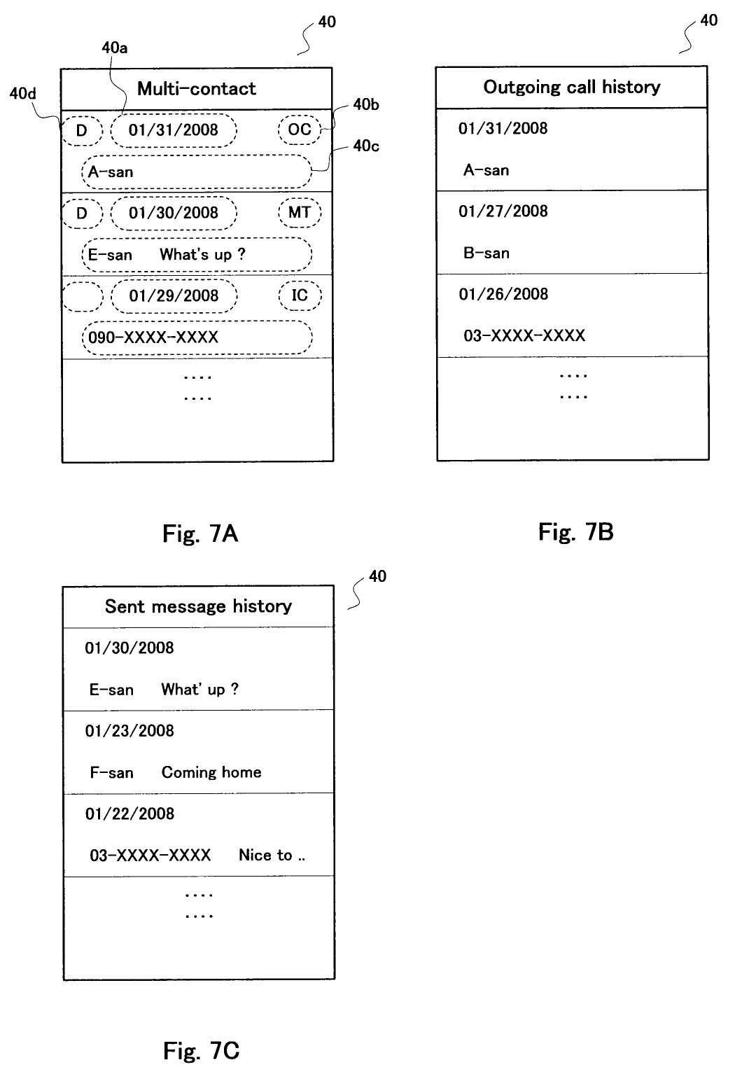

In this case, as shown in FIG. 7A, each entry data in the multi-contact data 34 is displayed on a screen 40 of the display unit 13 in order according to the entry number 34a. And the user selects one of the entry data from the screen by manipulating the key pad 15.

Also, as shown in FIG. 7A, each entry data displayed on the screen 40 may includes a date column 40a showing the date that a phone call is received or made, or a message is received or sent, a type column 40b showing a type such as an incoming call (IC), an outgoing call (OC), message transmission (MT), and message reception (MR), an address and title column 40c showing the name, the mail address, or the telephone number, and a subject of the message, and a duplication indication column 40d showing by “D” that at least two entries with the same name, mail address, or telephone number are registered in the multi-contact data 34.

If at least two entries with the same name, mail address, or telephone number are registered in the multi-contact data 34, one of the at least two entries with the most recent date may be displayed in the screen 40. For example, if an outgoing call is made to “A-san” on Jan. 31, 2008, and a message is received from “A-san” on Jan. 28, 2008, the entry data of the outgoing call to “A-san” with the most recent date is displayed in the screen 40. Of course, all entry data in the multi-contact data 34 may be displayed on the screen 40 even if they have the same name, mail address, or telephone number are registered.

While the entry data in the multi-contact data 34 is displayed, the control unit 20 checks whether one of the entries is selected so as to make a communication (Step S109). If no selection is received (No at Step S109), the control unit 20 continues to check a reception of the selection. If one of the entries in the multi-contact data 34 is selected by manipulating the key pad 15 (Yes at Step S109), the control unit 20 executes processing regarding the phone call or the message transmission according to the selected entry (Step S111). Concretely, if IC or OC is displayed in the type column 40b of selected entry, the control unit 20 makes the phone call based on the telephone number of the selected entry. If the MT or the MR is displayed in the type column 40b of the selected entry, the control unit 20 displays a mail creation screen on the display unit 13.

After the phone call is made or the message is sent, the control unit 20 updates the outgoing call history data 30 or the sent message history data 32, and the multi-contact data 34 (Step S113). In this case, new information based on the phone call or the message transmission is registered in the entry identified by the entry number 1.

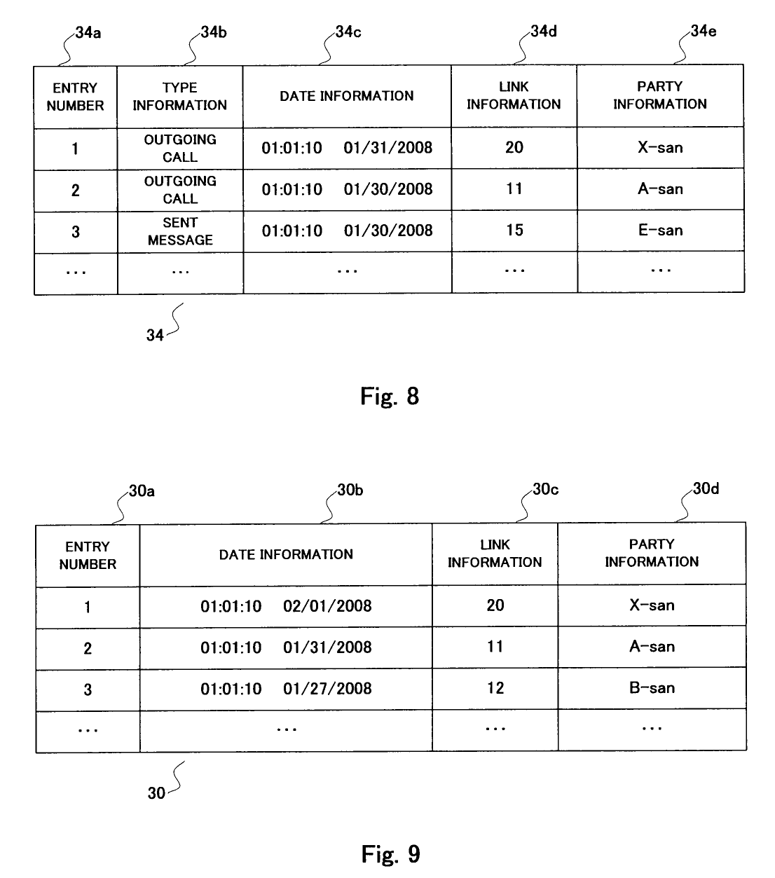

For example, in Step S111, if the user made a phone call to “X-san” at 01:01:10 on Feb. 1, 2008 by selecting the entry in the multi-contact data 34, as shown in FIG. 8, outgoing call is registered in the type information 34b, “01:01:10 02/01/2008” is registered in the time and date information 34c, “20” is registered in the link information 34d, and “X-san” is registered in the party information 34e respectively. At the same time, with the update, the entry number for each entry that has been registered moves down by one.

Also, as shown in FIG. 9, a new entry data whose time and date information 30b is “01:01:10 02/01/2008”, link information 30c is “20”, and party information 30d is “X-san” is registered into the entry identified by the entry number 1 in the outgoing call history data 30. Likewise, with the update, the entry number for each entry that has been registered moves down by one.

If the multi-contact data 34 is not instructed to be displayed (No at Step S103), the control unit 20 checks whether the instruction is to display one of the history data 30 through 33 (Step S115). If one of the history data 30 through 33 is to be displayed (Yes at Step S115), the control unit 20 reads out the designated one of the history data 30 through 33 from the storage device 26 (Step S117).

The control unit 20 displays the designated history data obtained in Step S117 on the display unit 13 (Step S119). For example, if the designated history data is the outgoing call history data 30, each entry in the outgoing history data 30 is displayed in order on the screen 40 of the display unit 13 as shown in FIG. 7B. On the other hand, if the designated history data is the received message history data 32, each entry in the received message history data 32 is displayed in order on the screen 40 of the display unit 13 as shown in FIG. 7C. Thus, the user can select a desired entry by manipulating the key pad 15. If a group address or plurality of mail addresses is registered in the sent message history data 32, the group address or the plurality of mail addresses is/are displayed in one entry. In this case, a list of mail addresses contained in the group address or the plurality of mail addresses may be displayed in place of the message history data 32 so that the user can select at least one mail address.

The control unit 20 checks whether one entry is selected from the designated history data (Step S121). If no selection is executed (No at Step S121), the control unit 20 continues the check until the selection of the one entry is received. On the other hand, if one entry is selected from the designated history data (Yes at Step S121), the control unit 20 makes the outgoing call or displays the mail creation screen on the display unit 13 (Step S111).

After the outgoing call is made or message which is created based on the mail creation screen is sent, the control unit 20 updates the multi-contact data 24, and the outgoing call history data 30 or the sent message history data 32 in the storage device 26 by registering the information regarding the outgoing call or the message transmission in the entry identified by the entry number 1 (Step S113).

For example, in Step S111, if the user made a phone call to “X-san” at 01:01:10 on Feb. 1, 2008 by selecting the entry in the outgoing call history data 30, as shown in FIG. 8, outgoing call is registered in the type information 34b, “01:01:10 02/01/2008” is registered in the time and date information 34c, “20” is registered in the link information 34d, and “X-san” is registered in the party information 34e respectively. At the same time, with the update, the entry number for each entry that has been registered moves down by one.

Also, as shown in FIG. 9, a new entry data whose time and date information 30b is “01:01:10 02/01/2008”, link information 30c is “20”, and party information 30d is “X-san” is registered into the entry identified by the entry number 1 in the outgoing call history data 30. Likewise, with the update, the entry number for each entry that has been registered moves down by one.

On the other hand, none of the history data 30 through 33 is instructed to be displayed (No at Step S115), the control unit 20 checks whether the instruction is to make the outgoing call after a telephone number to be dialed is inputted directly via the key pad 15 or read out from the phonebook data in the storage device 26, or to display the mail creation screen on the display unit 13 (Step S123). If no instruction for making the outgoing call or displaying the mail creation screen is received (No at Step S123), the control unit 20 waits for the instruction for making the outgoing call or displaying the mail creation screen. Of course, another instruction other than the instruction making the outgoing call and displaying the mail creation screen may be inputted. In this case, the control unit 20 executes processing designated by the other instruction.

If the instruction is to make the outgoing call or display the mail creation screen (Yes at Step S123), the control unit 20 makes the outgoing call or displays the mail creation screen on the display unit 13 (Step S111).

After the outgoing call is made or message which is created based on the mail creation screen is sent, the control unit 20 updates the multi-contact data 34, and the outgoing call history data 30 or the sent message history data 32 in the storage device 26 by registering the information regarding the outgoing call or the message transmission in the entry identified by the entry number 1 (Step S113).

Thus, when the user tries to make an outgoing call or to send the message, the cellular phone 1 provides the user with the multi-contact data 34 in response to the user's request. Therefore, the user can select contact information with little key manipulation regardless of whether there was a phone call or message transmission.

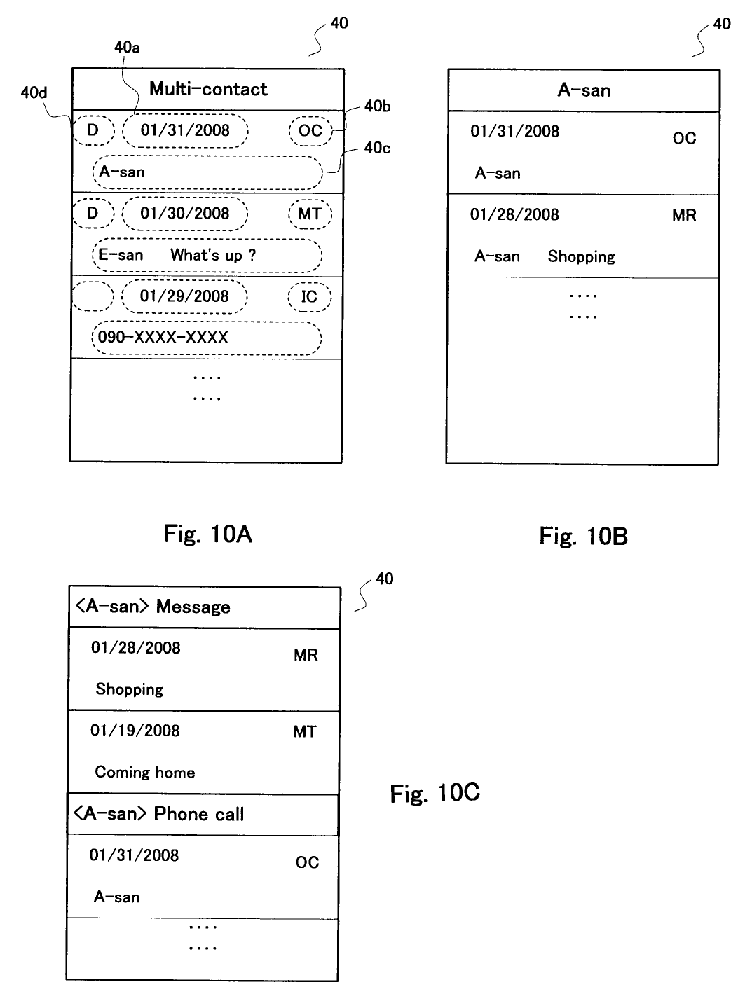

Also, as shown in FIGS. 10A and 10B, responding to the selection of the entry regarding “A-san” by manipulating the key pad 15 while each entry data in the multi-contact data 34 is displayed on the screen 40 of the display unit 13, all entry data regarding “A-san” in the history data 30 through 33 may be displayed on the screen 40 of the display unit 13 in order according to the date information 30b, 31b, 32b, and 33b in the history data 30 through 33. Furthermore, as shown in FIG. 10C, all entry data regarding “A-san” read out from the history data 30 through 33 may be displayed by type such as outgoing call, incoming call, message transmission, and message reception.

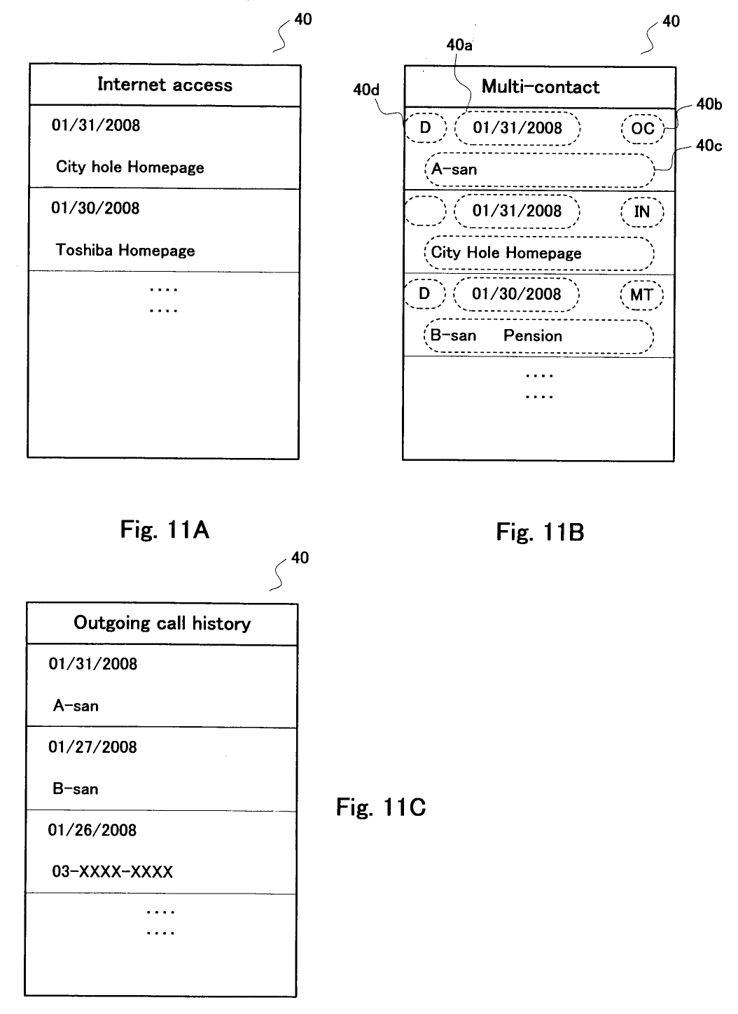

Also, an access history to Web sites and so on via the internet may be stored in the storage device 26. In response to the user's request, an internet access history may be displayed on the screen 40 of the display unit 13 as shown in FIG. 11A. Or, as shown in FIG. 11B, the most recent access data in the access history data may be displayed together with the entry data in the multi-contact data 34. In FIG. 11B, “IN” in the type column 40b indicates an internet access.

In the embodiment above, it is described that multi-contact data 34 includes the most recent data in each of the history data 30 through 33. However, the multi-contact data 34 may include a predetermined number of recent data in each of the history data 30 through 33. In this case, in response to the user's request, one type of history data from the outgoing call, the incoming call, the message transmission, and the message reception in the multi-contact data 34 may be displayed on the screen 40 of the display unit 13. FIG. 11C shows an example of the entry data displayed on the screen 40 of the display unit when the user requests the entry data regarding the outgoing call in the multi-contact data 34 to be displayed on the screen 40.

In the embodiment above, it is described that the entry data in the history data 30 through 33 and multi-contact data 34 is arranged in order according to the date information 30b, 31b, 32b, 33b, and 34b. However, the entry data may be arranged according to frequency information or priority information. Also, when displaying the entry data on the screen 40, color and font size may be varied according to the priority information determined according to date or frequency.

Furthermore, time information including hour, minute, and second may be displayed together with the date information on the screen 40. Also, when displaying the entry data contained in the multi-contact data 34, at least one kind of entry data may be displayed on the screen 40 of the display unit 13 by selecting the kind from the outgoing call, the incoming call, the message transmission, and the message reception.

Furthermore, when displaying plural kinds of entry data on the screen 40, the entry data regarding the phone call may be displayed by scrolling down and the entry data regarding the message transmission and reception and the internet access may be displayed by scrolling up or vice versa.

Furthermore, communication history regarding a short-range wireless communication based on the Bluetooth® and the IEEE 802.11 methods.

In the above description, the cellular phone 1 is used to explain the embodiment. However, this invention can be applied to a PHS (Personal Handyphone system) and a PDA (Personal Digital Assistant).

The cellular phone 1, or any of the other devices referred to supra, performs a portion or all of the processing steps of the above-noted embodiments in response to the main control unit 20 (and its CPU and associated control units) executing one or more sequences of one or more instructions contained in a memory, such as the storage device 26. Such instructions may be read into the storage device 26 from another computer readable medium, such as a hard disk or a removable media drive. One or more processors in a multi-processing arrangement may also be employed to execute the sequences of instructions contained in the storage device 26. In alternative embodiments, hard-wired circuitry may be used in place of or in combination with software instructions. Thus, embodiments are not limited to any specific combination of hardware circuitry and software.

As stated above, the cellular phone 1 includes at least one computer readable medium or memory for holding instructions programmed according to the teachings of the above-noted embodiments and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium.

1. A communication apparatus, comprising:
a storage device configured to store communication history data which includes outgoing call history data including a telephone number of a person called, an incoming call history data including a telephone number of a caller, a sent message history data including a mail address of an addressee, and a received message history data including a mail address of who sent the received message, contact data which includes a part of each of the outgoing call history data, the incoming call history data, the sent message history data, and the received message history data, and to store phonebook data composed of at least one entry including plural of identification data identifying the entry, a telephone number, a mail address, and party name;
a communication information extraction unit configured to extract one of a telephone number and a mail address from one of the communication history data and the contact data;
a communication unit configured to make an outgoing call and send a message based on the telephone number and the mail address, respectively, extracted by the communication information extraction unit; and
a data management unit configured to update the communication history data and the contact data after the communication unit makes the outgoing call or sends the message.

2. The communication apparatus according to claim 1, wherein the communication history data includes outgoing call history data including a telephone number of a person called, an incoming call history data including a telephone number of a caller, a sent message history data including a mail address of an addressee, and a received message history data including a mail address of who sent the received message.

3. The communication apparatus according to claim 2, wherein the outgoing call history data, the incoming call history data, the sent message history data, and the received message history data further include identification information which identifies whether the same telephone number or mail address is stored in the phonebook data.

4. The communication apparatus according to claim 2, wherein the contact data includes the most recent entry in each of the outgoing call history data, the incoming call history data, the sent message history data, and the received message history data.

5. A communication apparatus, comprising:
a storage device configured to store communication history data which includes outgoing call history data including a telephone number of a person called, an incoming call history data including a telephone number of a caller, a sent message history data including a mail address of an addressee, and a received message history data including a mail address of who sent the received message, contact data which includes a part of each of the outgoing call history data, the incoming call history data, the sent message history data, and the received message history data, and to store phonebook data composed of at least one entry including plural of identification data identifying the entry, a telephone number, a mail address, and party name;
means for extracting one of a telephone number and a mail address from one of the communication history data and the contact data, respectively;
means for making an outgoing call based on the telephone number extracted by the extracting means;
means for sending a message based on the mail address extracted by the extracting means; and
means for updating the communication history data and the contact data after making the outgoing call or sending the message.

6. The communication apparatus according to claim 5, wherein the communication history data includes an outgoing call history data including a telephone number of a person called, an incoming call history data including a telephone number of a caller, a sent message history data including a mail address of an addressee, and a received message history data including a mail address of who sent the received message.

7. The communication apparatus according to claim 6, wherein the outgoing call history data, the incoming call history data, the sent message history data, and the received message history data further include identification information which identifies whether the same telephone number or mail address is stored in the phonebook data.

8. The communication apparatus according to claim 6, wherein the contact data includes the most recent entry in each of the outgoing call history data, the incoming call history data, the sent message history data, and the received message history data.

9. A communication method, comprising:
receiving and sending voice and text data using a communication device having a memory;
storing attribute data including attributes of the voice and text data in the memory;
organizing the attribute data of the voice and text data by attribute;
displaying on a display of the communication device attributes of both the voice and text data at the same time.

10. The method according to claim 9, comprising:
organizing said attribute data into categories;
wherein said attribute data of the voice and text data include plural of time information, date information, party information identifying who sent the message, and information identifying whether the party information is stored in the memory associated with more than one category.

11. The method according to claim 9, comprising:
storing said attribute data in categories including outgoing voice information, incoming voice information, incoming text information and outgoing text information.
